(19) United States
(12) Patent Application Publication
(10) Pub. No.: US 2008/0318751 A1
(43) Pub. Date: Dec. 25, 2008

(54) One-piece integrated paper art and method for making the same

(76) Inventor: Chia Shun Lee, Taoyuan County (TW)

Correspondence Address: COVENANT IP CONSULTING CO., P.O. BOX 34-306 TAIPEI CITY, TAIPEI, 10499, TW

(21) Appl. No.: 12/143,812

(22) Filed: Jun. 22, 2008

(30) Foreign Application Priority Data
Jun. 25, 2007 (TW) 096122824

(51) Int. Cl. B31B 1/14

(52) U.S. Cl. 493/340

(57) ABSTRACT

A method of generating an integrated module directly by the design patterns of a cardboard, a method of modularizing a variety of paper crafts can transform to a method of combining a set of modules into an integrated module via pattern designs. In addition to using double etching to etch directly the cutting lines, perforation dots, embossments, and protrusion dots on a thick steel plate to be a male die of the module, the present inventions is characterized in that the differences of the fissures among the modules and the thicknesses of the plates are used to reach the effects of holes and extensions, and it has force points on the same level while it generates different effects at the same time.

### BACKGROUND OF THE INVENTION

1. Field of the Invention

The present invention relates to paper craft tooling manufacturing technology, especially related to a method of integrating tools such as knife die, embossing die, perforation tool, dry embossing pen, and color painting. Also, the invention relates to a die manufacturing method combining cutting, perforating, embossing, embroidering, protruding and color painting.

2. Description of the Prior Art

Paper craft is becoming one of the most popular arts in recent years. People are not satisfied only with cardboard cutting and embossing. Parchment paper made by tracing lace patterns on the trace papers by perforation pen and embossing pen, and paper embroidery made by embroidering on cards are becoming the current trend, and they are widely used in daily lives.

However, tools seen in the field of paper craft are not multi-functioned. That means, different tools are used when different techniques are applied. Traditional knife die with knife fixed on the die plate or the etched knife die, or the knife die made by multi-etching (as shown in FIG. 1b) which is the prior invention of the inventor, are used for cutting patterns. Besides, an embossing die made by copper die and a folder type embossing tool set which is the prior invention of the inventor (as shown in FIG. 1a) are used only for embossing cardboards. There are many types and dimensions of perforation pens (as shown in FIG. 1e) and dry embossing pens (as shown in FIG. 1f), such as golf embossing pen, drop-like needle pen, one-needle pen, three-needle pen, L-shape needle pen, regular embossing/needling two-way mesh, embossing/needling plate (as shown in FIG. 1d, element 19), needle pad (as shown in FIG. 1d, element 20), and other embossing pens with various diameters. A beginner is hard to make a paper craft unless he/she is provided with all kinds of tools. The more difficult part is that manipulating every tool needs plenty of hand work. Therefore, even in a taste-oriented environment people live right now, such diverse and various tools and techniques still are a big burden for the attempted people.

Regarding the prior arts, it is impossible to use the same die or module for both embossing and cutting. Conventional embossed cardboards are cut in several ways: 1. cut by scissors 2. cut by knife 3. perforating a row of perforations and tearing it off. The reasons why a knife die cannot be used are: 1. the knife die could destroy the embossment 2. difficulty in positioning. In other words, if a knife die is applied then positioning is the most pressing problem.

Why does perforating tools stay in the way making perforated holes one by one as the perforation pen 16 does? The reason is that it is almost impossible and unsafe for the user to perforate a pattern entirely in one-time perforating with uniform size perforated holes having uniform distance and pressure. Therefore, warp and woof needling meshes and pre-perforated paper embroidering plate 19 facilitate positioning. However, almost all the users admit that a mistake in perforation will turn hours or even days of efforts into nothing.

Making parchments takes no less effort than the embroidery, and it even needs more kinds of tools such as embossing pens with different diameters and needling pens adapted to perforating. It takes hours or even days of work to complete a handicraft.

In recent years, paper embroidery, embroidering patterns on papers rather than cloths, is developed. In European and American countries paper embroidery is becoming a trend because of its features of firmness as cardboards and stereoscopic lines, and because it is capable of being adhesive, writable, and easy to color.

FIG. 1 is a conventional die or tool for use of paper craft. FIG. 1a is a schematic view of embossing module made by etching (Taiwanese patent number 1251555) invented previously by the present inventor. FIG. 1b is a schematic view of knife die made by multiple etching (Taiwanese patent number 1252537). These are all dies invented for the paper craft. FIG. 1c is a schematic view of perforation pen and an embossing pen used on cardboards; FIG. 1d is a schematic view of accommodating needle pad with use of embossing/needling die plate; FIG. 1e is a schematic view of using a perforation pen to perforate. FIG. 1f is a schematic view of using an embossing pen to emboss. These are the most common tools used in paper craft, the only differences are the number of the needles varies or the diameter of the embossing pen varies.

From the prior arts described above, we can find out from FIG. 1a to FIG. 1f that the tools are different in shapes. It is almost impossible to combine or to assemble the tools. There is only male knife die and no female die; embossment is hard to form without a female embossing die. Perforations and paper embroidery can be done without the above dies, however they require skillful and crafty hands. As a result, traditional tools such as scissors, needles, knives, embossing pens may be needed to complete every piece of handicraft. Though it is often called purely hand made, personalized, the truth is that too many human factors and uncertainties result in huge differences among those works. Among those techniques, only one of them can apply knife dies or embossing dies, while others rely on hand work. The reason is: there is no such die that can apply various techniques.

### SUMMARY OF THE INVENTION

It is the main object of the present invention to solve the problem of forming various modules at one time.

It is still another object of the present invention to solve the problem of precisely fixing the positions among different modules.

It the final object of the present invention to allow the module manufacturers to produce a fast, precise, easy-to-operate and economic paper craft module without too many design techniques. This allows the paper craft to become a leisure activity but also it brings warmth and love to the society while a fast and creative card made by such module is sent out, which is the most important goal of the present invention.

The greatest feature of the present invention is using a single module to complete all the shaping effects by integrating all the complicated techniques to achieve different shapes in one time.

The second feature of the present invention exists in that from the shape of the module, the patterns to be shaped on the cardboard are foreseeable providing a complete concept for the designers.

The third feature of the present invention is: lowering the entrance barrier of paper craft and allowing the creators develop their ideas. Meanwhile, the invention provides a way to rapidly create a great deal of nice card designs without spending too much time.

The most unique part of the present invention is the breakthrough of the conventional concept: knives, needles and male dies do not exist in a single module and do not form together; cutting and perforating did not apply to a module of male and female dies; needles are impossible to be formed by etching. Therefore, all the paper craft workers are mentally hurt if they have to redo their paper works when a mistake occurs. In hundreds of years, the tools paper craft workers use are still ranged in hand knives, needles and embossing pens, and they perform cutting or perforating on the cardboards by hand. In the mean time, the same design can be repeated by using the module of the present invention.

In order to assemble all the tools in one module plate, the most important part is to create a module which can be commonly used in every technique. However, it is not enough. If the cardboard deforms after pressed by the dies, forming the patterns in one module will be meaningless.

The problems need to be solved in the present invention are:
1. All the tools should appear as a part of the module. The embossing die, the protruding die, or the cutting and perforating dies all should include male and female dies.
2. For processing the cardboard, every type of male die base should remain in the same level to avoid deforming the cardboard.
3. For making the module, top of every type of the male die should remain in the same level to avoid difficulties.
4. The female die only exists in a single sheet.
5. Engineering limitations.

The inventor has found that etching technique is the best solution after analyzing the problems above. In accordance with past experiences and techniques, the present invention processes the patterns to have cutting lines with about 0.1 mm diameters, perforations with about 0.1 mm diameters, and to have embossments and protrusions the same as the design pattern on a steel plate with anti-etching protection, while another side of the plate is processed with anti-etching entirely, and then the patterns can be etched to have cavities with same depth in a predetermined etching time. When the anti-etching layer is taken off, by means of multi-etching process, the male die plate with the knife die, the embossing die, the perforating die and the protruding die having the same highest point and the same base is finished.

To summarize the features of the present invention, the fissures in the embossing dies and the protruding dies should be larger to allow the cardboard to be received therebetween, while the fissures in the perforating dies and the cutting dies should be very small so that the perforation male die or the cutting male die can pierce through the cardboard. These are the differences between the embossing/protruding dies and the cutting/perforating dies.

The female die of the present invention utilizes the thickness of the cardboard and the height of the embossment to keep the cutting female die to have connection with the thickness of the cardboard, and thus two sides of the cutting die will not separate.

The present invention also has a perforation die plate processing method. The perforation patterns are covered by a round dot with 0.1 mm diameter using anti-etching film on a steel plate. Then, use the multi-etching technique to etch a perforation die plate having shapes of needle dots. For the sake of safety, a foam sheet can be disposed above the needle; also, a corresponding perforation female die plate can be placed to form a perforation module.

The female die plate of the present invention originally has the anti-etching patterns opposite to the patterns on the male die plate. However, the design with greater fissures and smaller fissures generates a combination of different shapes. Specifically speaking, the cutting female die appears only on the side facing the male die plate, so that the female die plate won't be separated during cutting.

The present invention substantially relates to a method of combining all types of shape modules. The module of the present invention assembles the modules with specific functions. Any paper craft design can easily turn into a male die anti-etching plate and a female die plate with two anti-etching sides in the integrated module. Therefore, an integrated module with cutting, embossing, perforating, protruding and painting techniques is precisely made.

### BRIEF DESCRIPTION OF THE DRAWINGS

FIG. 1 is a schematic view of the conventional die or tool used in the paper craft.

FIG. 1 a is a schematic view of the embossing die made by etching of the present invention;

FIG. 1b is a schematic view of the cutting die made by multi-etching of the present invention;

FIG. 1c is a schematic view of the conventional perforating pen and embossing pen used on the cardboard;

FIG. 1d is a schematic view of using the embossing/perforating die plate with perforating pad;

FIG. 1 e is a schematic view of the perforating pen while perforating;

FIG. 1f is a schematic view of the embossing pen while embossing;

FIG. 2 is a schematic view of the perforating mode of the present invention;

FIG. 3 is a schematic view of the protruding mode of the present invention;

FIG. 4 is a schematic view of the cutting mode of the present invention;

FIG. 5 is a schematic view of the embossing mode of the present invention;

FIG. 6 is a schematic view of the processing mode of the present invention;

FIG. 7 is a schematic view of another processing mode of the present invention;

FIG. 8 is a schematic view of comparison among each element in the present invention;

FIG. 9 is a schematic view of processing the cutting module of the present invention;

FIG. 10 is a schematic view of assembly of cutting, perforating and embossing of one embodiment of the present invention;

FIG. 10a is a schematic view of rear side of the female die plate in one embodiment of the present invention;

FIG. 10b is a schematic view of front side of the female die plate in one embodiment of the present invention;

FIG. 10c is a schematic view of front side of the male die plate in one embodiment of the present invention;

FIG. 11 is a schematic view after the cardboard being processed;

FIG. 11a is a perspective view after the cardboard being processed; and

FIG. 11b is a cross-section view after the cardboard being processed.

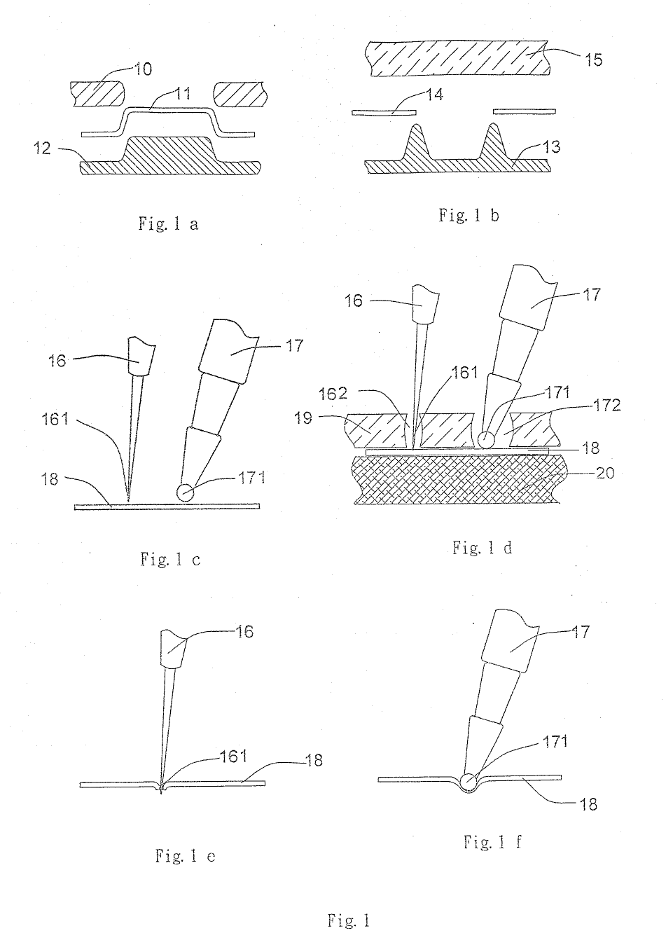

### DETAILED DESCRIPTION OF THE PREFERRED EMBODIMENT

The present invention, according to different shapes and functions, mainly divides into four basic features.

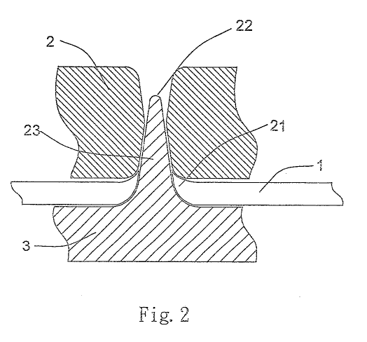

FIG. 2 is a schematic view of the die of the present invention in perforation mode. Thickness of the female die plate 2 is substantially equal to the summation of height of the perforation male die 23 and thickness of the cardboard 1. Since the fissure between the perforation male die 23 and the perforation female die aperture 22 is small, the cardboard 1 is perforated from the perforation 21 by the perforation male die 23.

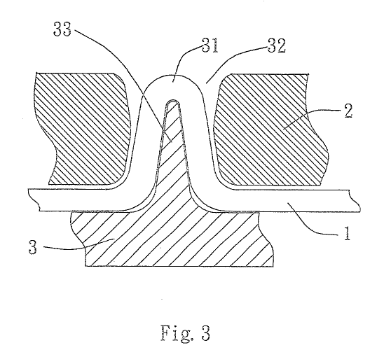

FIG. 3 is a schematic view of the protruding mode of the present invention. The thickness of the female die plate 2 is substantially equal to the summation of the height of the protrusion male die 33 and the thickness of the cardboard 1. The fissure between the protrusion male die 33 and the protrusion female die aperture 32 allows the cardboard 1 to be received therebetween, and the cardboard 1 is extruded as an embroidery protrusion.

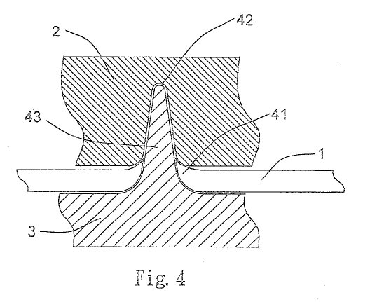

FIG. 4 is a schematic view of the cutting mode of the present invention. The thickness of the female die plate 2 is substantially equal to the summation of the height of the cutting male die 43 and the thickness of the cardboard 1. Since the fissure between the cutting male die 43 and the cutting female die aperture 42 is small, and the depth of the cutting female die aperture 42 is about the depth of the cutting male die 43 subtracting the thickness of the cardboard 1, the cardboard 1 is cut at the point of the cardboard cutting opening 41 by the cutting male die 43.

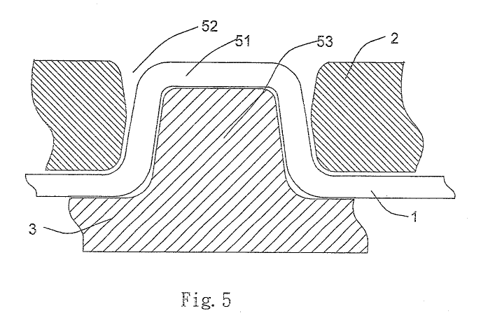

FIG. 5 is a schematic view of the embossing mode of the present invention. The thickness of the female die plate 2 is substantially equal to the summation of the height of embossing male die 53 and the thickness of the cardboard 1. The fissure between the embossing male die 53 and the embossing female die aperture 52 allows the cardboard 1 to be received therebetween. The cardboard 1 is extruded as an embossing pattern.

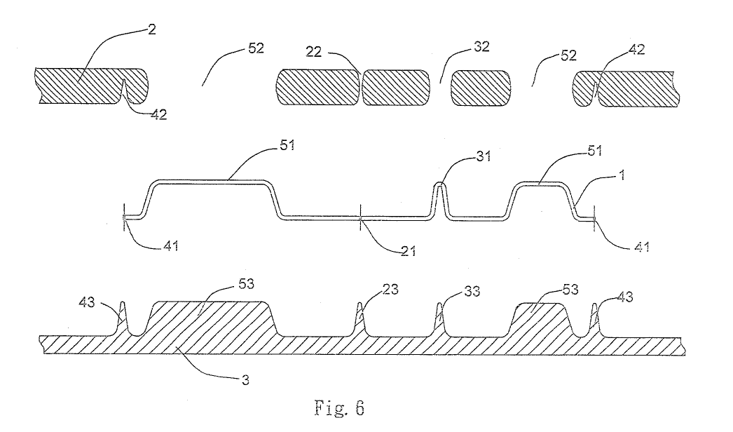

FIG. 6 is a schematic view of the processing mode of the present invention. The male die plate 3 is a steel plate with 0.6 mm thickness, the female die plate 2 is a steel plate with 0.4 mm thickness, the thickness of the cardboard 1 is about 0.1 to 0.2 mm. After the cardboard 1, intermediating the female die plate 2 and the male die plate 3, is pressed by the roller, the cardboard 1 is separated into two at the point of the cardboard cutting opening 41 by the cutting male die 43, the perforation male die 23 perforates the cardboard 1 at the perforation 21, and the embossing male die 53 extrudes an embossing pattern at the embossed surface 51; all kinds of patterns are formed at once.

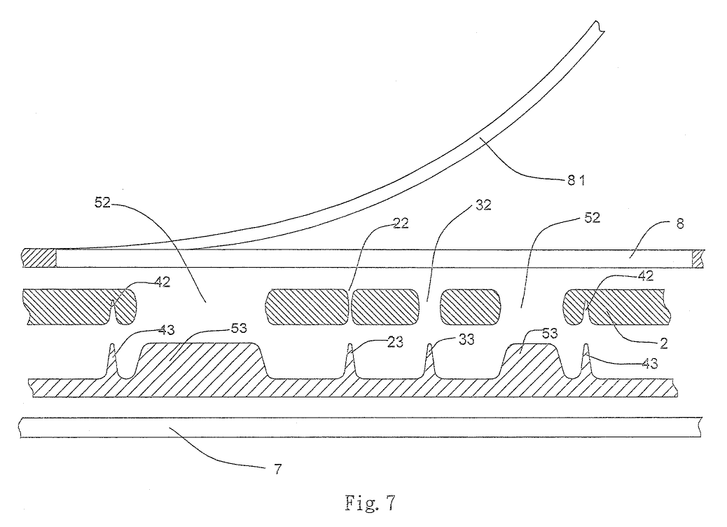

FIG. 7 is a schematic view of another processing mode of the present invention. For the purpose of alignment, the female die plate 2 and the male die plate 3 are respectively disposed between the base plate 7 of the folder of the male die plate 3 and the fix plate 8 of the folder of the female die plate 2. The fix plate 8 has a color-paint fold page 81 allows users to paint on the embossed surface 51 or the protrusion surface 31 of the cardboard 1 after pressing.

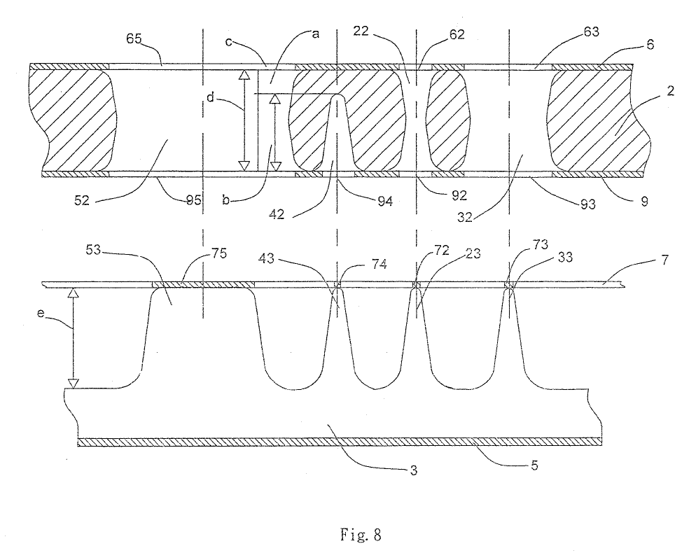

FIG. 8 is a comparison view among the basic elements of the present invention. The present invention utilizes the design pattern to make an anti-etching mask film and applies the double etching techniques together to double etch the steel plates under the mask film. By controlling the pressure and the time of etching, a needle shape perforation male die 23 is formed under the mask film 72 with a 0.1 mm diameter round point. A mask film 73 with a larger diameter point forms a protrusion male die 33 of the embossing pen. The mask film 74 having a line width around 1 mm etches a blade-like cutting male die 43. The mask film 75 with embossed pattern etches an embossing male die 53. The above-mentioned mask film determines the predefined pattern on the cardboard 1 and the key feature is the female die plate 2.

The etching depth e of the male die plate 3 is substantially equal to the thickness d of the female die plate 2. Such design makes the male die plate 3 and the female die plate 2 to become an integrated die plate after pressing, reaching a pressure balancing effect. The cutting male die 43 retains the portion a to connect with the female die plate 2 so as to hold the integrity of the female die plate 2.

Every element in the present invention can be an individual die plate; especially the dies of the cutting element and the perforation element can be replaced by the foam sheet and become a tool of single function.

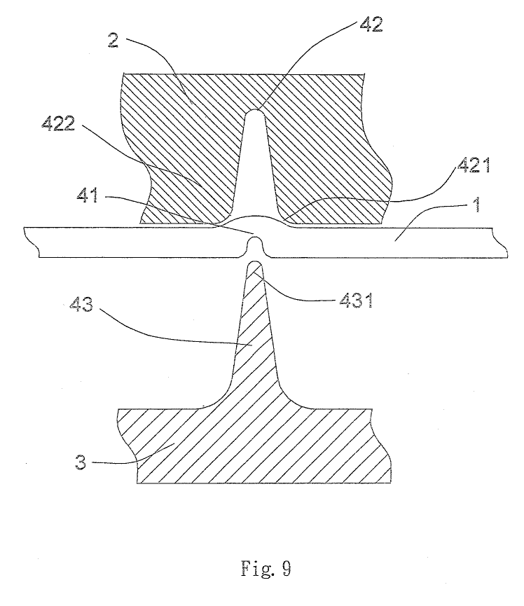

FIG. 9 is a schematic view of the applied force of the cutting die of the present invention. The cutting opening 431 and the cutting points 421, 422 at two sides of the cutting female die aperture 42 help the cutting effect in the process when the female die plate 2 and the male die plate 3 push each other.

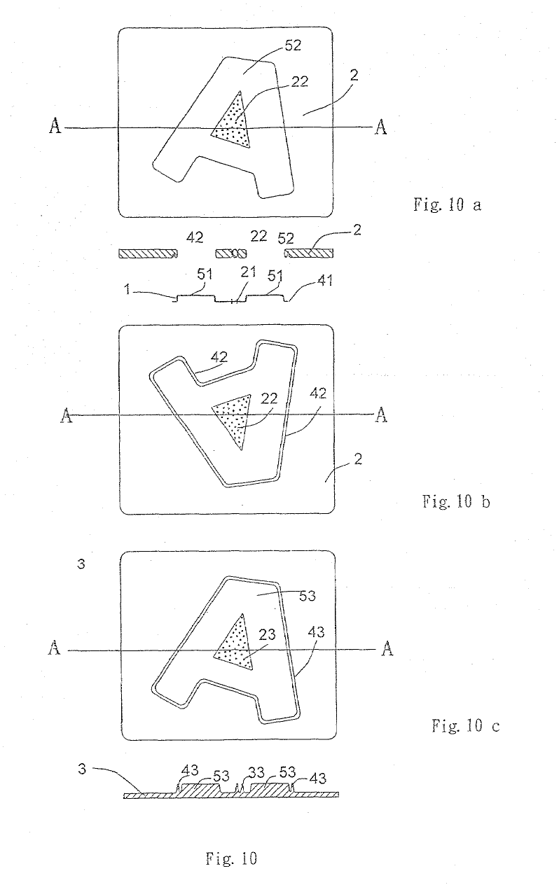

FIG. 10 is one embodiment of the present invention combining cutting, perforating and embossing in one module. The embossment “A” has numerous perforations 21 inside the triangle area. An encircling cutting line is disposed outside the pattern “A”. FIG. 10a is a reverse side of the female die plate 2 in one embodiment of the present invention. This figure does not show the line of the cutting female die aperture 42 on the front side of the female die plate 2, as shown in FIG. 10. In other words, the cutting female die aperture 42 does not penetrate the female die plate 2, so as to keep the integrity of the female die plate 2. FIG. 10c is a front view of the male die plate in one embodiment of the present invention. What is shown in the figure is the plan view of the cardboard 1 processed, which also shows simplicity and accuracy when making the male die plate 3 in the present invention.

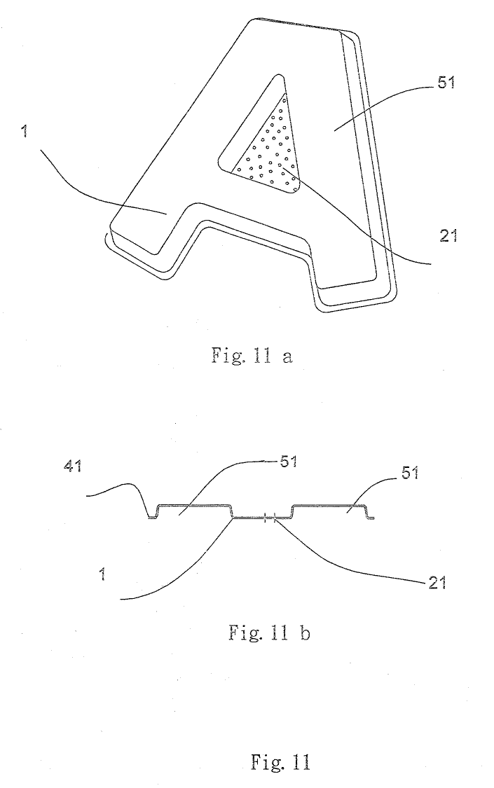

FIG. 11 shows the cardboard 1 after being processed. FIG. 11a shows a perspective view of the cardboard after being processed, and FIG. 11b is a sectional view of the cardboard after being processed.

From the figures shown above, we can clearly understand the present invention: the present utilizes a spray technique with uniform swing and multi-etching technique for finishing the shape of the anti-etching film mask. Shaping modules are assembled by the die plate and are processed by etching, so that cutting, perforating, embossing, embroidering, and protruding die modules can be done simultaneously. Therefore, processes on cardboards such as cutting, perforating, embossing, embroidering, and protruding can be done at once.

In conventional embossments, the only way to cut off the rim is to cut by scissors; the only way to making perforations is perforate by needle. The present invention allows various of combinations of cutting, perforating, embossing, embroidering and protruding to combine in different designs. For example, one design can be an assembly of cutting, perforating, embossing, embroidering and protruding; another design can be cutting with embossing; still another design can be perforating with cutting, or perforating with embossing and protruding. The only concern is that the fissure in the embossing dies and the protruding dies should be larger to allow the cardboard to be received therebetween, and that the fissure in the perforating dies and the cutting dies should be very small so that the perforation male die or the cutting male die can pierce through the cardboard to achieve the perforating and cutting effect.

The most important steps are: drawing the cutting line on the cardboard pattern with a 0.1 mm diameter ink line, drawing the perforation dot with a 0.1 mm diameter solid ink dot, and drawing the embossing and protruding patterns with solid ink sections to produce a light sensing film provided for the male die, which allows the design patterns on the cardboard to be developed on the same film; increasing the diameter of the ink line and dot by about 0.01 mm to 0.1 mm, increasing the periphery of the ink sections by about 0.1 mm to 0.5 mm, producing a light sensing film provided for corresponding surfaces of the male die plate and the female die plate after highlight and reverse processing; producing again a light sensing film provided for corresponding surfaces of the male die plate and the female die plate, eliminating the highlight lines and then reversing to produce a light sensing film provided for the surface of the female die plate back on the male die plate; at last aligning the light sensing films at two sides of the female die plate with a thin steel plate covered with a photo-resist film to process exposure, etching; then aligning the male die plate film with one side of a thicker steel plate covered with a photo-resist film to process exposure, etching, de-film and re-etching.

As shown in FIG. 8:

1. using a width about 0.1 mm as the diameter 74 of the cutting line, then using a dot with diameter about 0.1 mm as the perforation dot 72, accommodating the embossment 75 or the protrusion 73 patterns to manufacture the film 7 for use of etching the male die plate 3.

2. Then, slightly widen two sides of the above cutting diameter 94 to be about 0.1 mm to 0.2 mm, widen the diameter 92 of the perforation dot to be about 0.1 mm to 0.5 mm, however the periphery of the embossment 95 or the protrusion 93 patterns are widen to be greater than the width of one cardboard, processed with reverse and highlight, then the film 9 for etching the front surface of the female die plate 2.

3. Eliminate the cutting line of the pattern done in step 2 and reverse the pattern then the film 6 for etching the front surface of the female die plate 2.

4. Take two pieces of same size steel plates as the die plates, one of which has a width of about 0.6 mm to 1.0 mm, while another has a width of about 0.4 mm to 0.7 mm. Two sides of the two die plates are both covered with a photoresist film. The thicker steel plate is mainly for use of male die plate 3, the film 5 and the film 7 are used for processing exposure and develop on the two sides; the thinner steel plate is for use of female die plate 2, the film 6 and the film 9 are used for processing exposure and develop on the two sides.

5. The process of double etching is known and not a part of the current invention.

The manufacturing process of the module with assembly of cutting, perforating, embossing, embroidering, protruding and painting is done.

The seemed simplicity of the present invention in fact is the most particular part of the present invention. Neither structures, work flows, nor materials are applied in the present invention; the invention completely uses the core techniques of multi-etching and folder type module and other techniques of combining various modules, to give synthetic effects that many tools cannot achieve, of which is the most value part of the present invention.

What is claimed is:

1. A method of generating an integrated module directly by the design patterns of a cardboard, by a male die processed by using double etching technique to etc directly a cutting line, a perforation dot, an embossment, and a protrusion dot on a steel plate with a first thickness; and by a female die made by fissures among different dies with a second thickness thinner than the first thickness, to accordingly generate the integrated module, the method being characterized in:
generating the techniques including cutting, perforating, embossing and protruding according to the fissures among each of the dots, the lines and the surfaces of the male die and the female die as well as the design technique of the female die, so that the design patterns on every cardboard generates the integrated module.

2. A method of generating an integrated module directly by the design patterns of a cardboard, comprising providing a method using a module to produce a cutting tool, a perforating die plate and a method of generating an integrated module that produces at least two techniques of cutting, perforating, embossing and protruding, the method comprising:
drawing a cutting line on the cardboard design pattern with a 0.1 mm diameter ink line, drawing a perforation dot with a 0.1 mm diameter solid ink dot, and drawing an embossing pattern and a protruding pattern with solid ink sections to produce a light sensing film provided for a male die, which allows the design patterns on the cardboard to be developed on the same film;
increasing the diameter of the ink line and the ink dot by about 0.01 mm to 0.1 mm, increasing the periphery of the ink sections by about 0.1 mm to 0.5 mm, producing a light sensing film provided for corresponding surfaces of the male die plate and the female die plate after a highlight and a reverse processes;
producing again a light sensing film provided for corresponding surfaces of the male die plate and the female die plate, eliminating the highlight lines and then reversing to produce a light sensing film provided for the surface of the female die plate back on the male die plate;
aligning the light sensing films at two sides of the female die plate with a thin steel plate covered with a photo-resist film to process exposure, etching, then aligning the light sensing film of the male die plate with one side of a thicker steel plate covered with a photo-resist film to process exposure, etching, de-film and re-etching; and
fitting the female die plate and the male die plate to each other and fixing the female die plate and the male die plate inside a folder so that the integrated module is completed.

3. The method of claim 2, wherein when the techniques of cutting and perforating are not combined with the techniques of embossing and protruding, the female die plate is replaced by a foam sheet.

4. The method of claim 2, the techniques of cutting, perforating, embossing and protruding being selectively combined with different numbers.

5. The method of claim 2, a transparent folder disposed on the outer side of the integrated module to fix the position of the integrated module.

6. The method of claim 2, a transparent folder with a lift page disposed on the outer side of the integrated module to fix the position of the integrated module.

7. The method of claim 2, wherein the female die is a foam sheet.

8. The method of claim 2, wherein the female die and the male die are made by etching on a metal plate.

9. The method of claim 2, wherein the female die and the male die are formed by a hard plastic.
